(19) United States
(12) Patent Application Publication
(10) Pub. No.: US 2023/0046530 A1
(43) Pub. Date: Feb. 16, 2023

(54) ENHANCED BIRD FEEDERS AND BATHS

(71) Applicant: Bruce Robertson, Kingston, NY (US)

(72) Inventor: Bruce Robertson, Kingston, NY (US)

(73) Assignee: Bard College, Annadale-on-Hudson, NY (US)

(21) Appl. No.: 17/392,499

(22) Filed: Aug. 3, 2021

(51) Int. Cl. A01K 45/00; A01K 39/01

(52) U.S. Cl. CPC A01K 45/002; A01K 39/01

(57) ABSTRACT

An enhanced bird activity station that is more attractive to birds than conventional designs. The bird activity station is provided with a surface that is configured to horizontally polarize any light reflected by the surface. The bird activity station may be a bird feeder with a housing for containing bird food and a platform mounted to the housing. The platform forms the substrate that horizontally polarized the light reflected by the surface and is made from a transparent polymer and a layer of dark paint applied to an opposing side of the substrate from the housing. The bird activity station may also be a bird bath formed from a bowl having a layer of dark paint applied thereto so that any water placed in the bowl will cooperate with the layer of dark paint to horizontally polarize any light reflected by the surface.

### STATEMENT REGARDING FEDERALLY SPONSORED RESEARCH AND DEVELOPMENT

This invention was made with government support under Grant No. G18AC00268 awarded by the United States Geological Survey. The government has certain rights in the invention.

### BACKGROUND OF THE INVENTION

### 1. Field of the Invention

The present invention relates to bird feeders and bird baths and, more specifically, to an approach for designing bird feeders and bird baths that improves the attractiveness of the feeders and baths to birds.

### 2. Description of the Related Art

Sunlight consists of electromagnetic rays vibrating at all possible planes perpendicular to the direction of its travel, but it can become polarized when its waves start to oscillate partially or entirely in a single plane. There are two primary sources of polarized light in nature: Sky and water. Unpolarized sunlight is scattered when it interacts with particles (e.g. gases and water droplets) in the atmosphere, but is polarized when its angle of reflection is perpendicular relative to an observer. The result is a characteristic celestial polarization pattern of a stripe of polarized light across the sky 90 from the sun. Sunlight can also undergo strong polarization via reflection from a waterbody. Rivers and lakes with darker substrates (e.g. mud) or higher turbidity (dissolved solids) absorb more transmitted light, and since surface reflected light is 100% polarized, darker waters that absorb more of the light transmitted into the water can polarize up to 80% of light they collectively reflect from its surface and interior.

A diverse range of animals are capable of perceiving the polarization of light and can use it as a rich source of information to guide key behaviors. The desert locust (Schistocerca gregaria) have evolved the ability to identify terrestrial sources of polarized light so that they might avoid drowning. Over 300 species of aquatic insects can see horizontally polarized light and use it to locate habitat suitable for survival and reproduction. Diverse terrestrial animals use the sky polarization pattern as a navigation cue in their short and long-distance movements. Birds have long been known to reorient in response to experimental manipulations of the sky-polarization pattern, and it's recently been discovered that they can see the sky polarization pattern and primarily use it to calibrate their magnetic compass. Birds should be pre-adapted to use this same sensory modality to locate water bodies, but this hypothesis remains untested.

Man-made objects can also act as strong polarized light sources. These include solar panels, glass buildings, automobiles, and asphalt. Most well-documented of these sources of polarized light pollution are smooth, dark-colored non-metallic objects which polarize light in the visual and ultraviolet ranges, but it has been less appreciated that shiny white objects are also capable of polarizing light in the ultraviolet range. And because avian vision is sensitive to light in the ultraviolet (300-400 nm) and visual range (400-700nm), it is possible that birds may see and/or rely-upon polarized light across a broad spectral range. Man-made objects polarize light more strongly than natural waterbodies (<80%), aquatic insects that associate higher degrees of polarization with water encountering these objects actually prefer them to natural water bodies and lay their eggs on them. If birds mistake glass buildings or solar panels for natural water bodies, they might collide with them while attempting to land, or assume water bodies are horizontally oriented, and therefore ignore their increasing proximity to objects they approach.

Accordingly, there is a need in the art for an approach for improving bird feeders and bird baths to have enhanced attractiveness by employing polarization of light reflected from the bird baths and feeders.

### BRIEF SUMMARY OF THE INVENTION

The present invention comprises an enhanced bird activity station that is configured to be more attractive to birds than conventional designs. More specifically, the bird activity station is provided with a surface that is configured to horizontally polarize any light reflected by the surface. In one embodiment, the bird activity station is a bird feeder. The bird feeder has a housing for containing bird food and a platform mounted to the housing. The platform forms the substrate that horizontally polarized the light reflected by the surface. The platform is formed from a transparent polymer and a layer of dark paint applied to an opposing side of the substrate from the housing. In another embodiment, the bird activity station comprises a bird bath. The bird bath is formed from a bowl having a layer of dark paint applied thereto so that any water placed in the bowl will cooperate with the layer of dark paint to horizontally polarize any light reflected by the surface.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic of an exemplary bird activity station according to the present invention configured as a bird feeder;

FIG. 2 is a schematic of an exemplary bird activity station according to the present invention configured as a bird bath;

FIG. 3A and FIG. 3B are a series of photographs and reflection-polarization characteristics (degree d (%) of linear polarization of reflected light) of, as seen in FIG. 3A, feeder bases, and as seen in FIG. 3B, bird baths, exposed to wild birds. Imagery represents the relative degree of horizontal polarization of test surfaces taken in human visual range (400-700 nm, above) and the ultraviolet (300-400 nm, below) taken at the Brewster angle of maximal polarization (vis=angle, uv=angle). Maximal degrees of polarization of each test surfaces are embedded. Imagery confirms that blacker and shinier test surfaces polarize a higher percentage of visible-range and ultraviolet light, that white-colored and shinier surfaces can also polarize light in the ultraviolet, and that we found a black material (Black 3.0©) that was highly effective at reducing its polarization signature; and

FIG. 4A through FIG. 4D are a series of graphs showing the effect of reflection-polarization patterns on songbird visits (±SE) to test surfaces shown in FIGS. 4A-4C, for feeder-based, and in FIG. 4D, bird bath-based experiments. The behavioral responses of Tufted Titmouse (FIG. 4A), Black-capped Chickadee (FIG. 4B) and all other species combined visits (FIG. 4C) were similar. In the first year of the study, visitation rates for the two black-colored surfaces were higher than for the white ones. In the second year of the study when replaced the black-matte treatment with a very low polarization treatment, bird visitations were highest only in the black-shiny treatment. Visitation rates of birds to bird baths were more than twice as high in the black treatment than in the white or aluminum foil treatments. Letters denote the differences between treatments as a result of post-hoc pairwise comparisons mean values are given with standard errors.

### DETAILED DESCRIPTION OF THE INVENTION

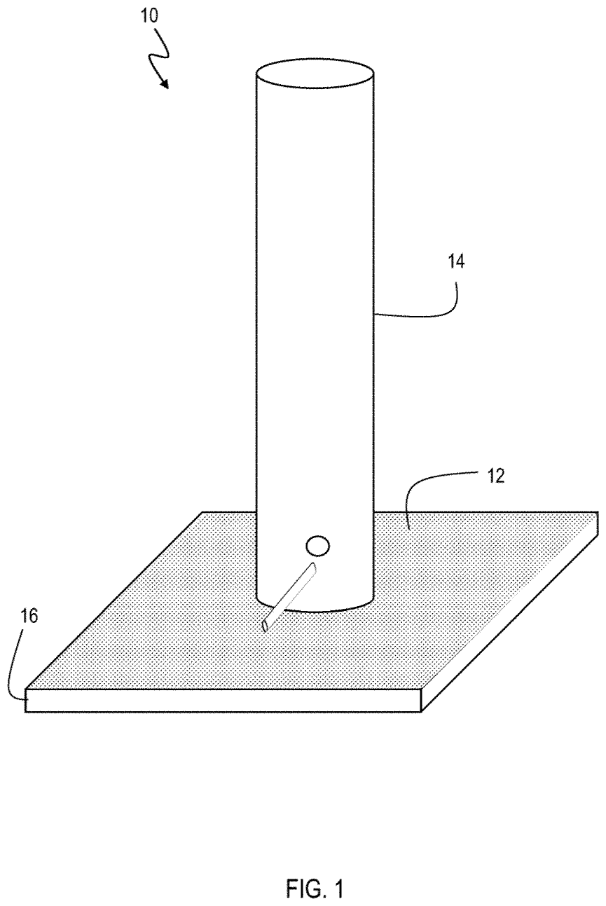

Referring to the figures, wherein like numeral refer to like parts throughout, there is seen in FIG. 1 an enhanced bird activity station 10, such as a bird feeder or bird bath, according to the present invention. Bird activity station 10 has at least one surface 12 that is very smooth and dark colored to polarize a high percentage of the reflected sunlight. In the example of a bird feeder, a housing 14 containing the bird feed may be coupled to a planar base 16 supporting surface 12. Surface 12 may be formed from a layer of transparent plastic, such as acrylic, that has a layer of black paint coating the opposing surface from housing 14. Thus, when station 10 is properly positioned for use, surface 12 will reflect horizontally polarized light upwardly toward the sky and attract birds to housing 14. For the purposes of the present invention, the term ‘dark’ is used to refer to the ‘value’ in the Munsell color system (0 to 10) in which lighter colors have higher values, darker-colors have lower values, and black has the lowest value. For the present invention, ‘dark’ refers to values from 0 to 3.

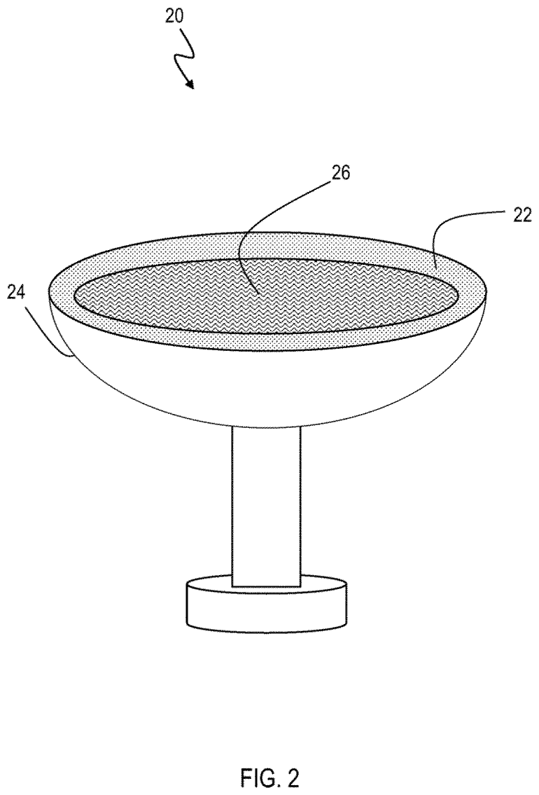

In the example of a bird bath 20, as seen in FIG. 2, the desired properties may be achieved by a surface 22 having a dark-colored (black) highly matte (not-shiny, but highly absorbing) color on the interior of the bowl 24. When the bowl is filled with water, the surface 26 of the water acts as the smooth surface to reflect polarized light. This combination of smooth surface 26 and dark absorbing surface 22 of the present invention that has been applied to creating bird feeders 10 and bird baths 20 could also applied to bird houses. As explained above, experimentation demonstrated that birds of every type encountered were more attracted to bird feeders and bird baths having polarizing characteristics according to the present invention.

### EXAMPLE

A series of multiple-choice field experiments were designed to determine if birds can detect terrestrial sources of horizontally polarized light and if they can use it to locate natural water bodies. First, modified bird feeders were used to determine if horizontally polarized light could make focal food sources more conspicuous to wild birds and guide their feeding behavior. In a second experiment, we allowed wild birds to choose to drink from, and bathe in, three water sources whose polarization properties varied in their degree and wavelength. We made inferences about the ability of birds to detect polarized light and their relative attraction to it in different behavioral contexts from the relative number of visits birds made to different treatments over the course of an observation period.

### Methods

Study Sites

Three field experiments were conducted at 38 sites in Dutchess, Columbia, and Ulster Counties, N.Y., USA. Research was conducted from November-March 2018-2020 on the Bard College Campus, the Tivoli Bays Wildlife Management Area and on private residential properties throughout the region. Experiments were placed on mowed lawns at the edge of forest stands.

Imaging Polarimetry and Spectroscopy of Test Surfaces

As a general rule, smooth, dark-colored man-made objects are stronger polarizers of reflected light. Because color is typically intertwined with polarization ability, in order to make inferences about the ability of birds to see and behavioral respond to polarized light vs. color, we designed test surfaces that were able to manipulate color more independently of their degree of reflection-polarization. The degree to which test surfaces could polarize light (d=% of reflected photons polarized) was quantified along with spectral irradiance of test surfaces across the range of light that birds are known to detect (300-750 nm).

Imaging polarimetry in visible wavelengths was conducted using a Canon DSLR that had been converted into an imaging polarimeter following processes and technical specifications described previously. An imaging polarimeter was designed and constructed to be capable of seeing only in the ultraviolet range. A Nikon DSLR was used with a number of modifications: 1) a near-pass optical filter was replaced with a UV-transmitting linearly polarizing filter that blocked the longer visible wavelengths while allowing ultraviolet light to pass through, and 2) 60 mm focal length UV-transmitting crystalline macro lens was attached (after Szaz et al. 2016). Processing of all imagery was done using AlgoNet© software using optical data taken in the blue (450 nm), green (550 nm), and red (650 nm) wavelengths. There was little difference in the degree, angle, and area of reflected polarized light among the three wavelengths so we present polarimetry in the blue. Polarimetric measurements were taken in a under sunny skies with the optical axis of the polarimeter aimed toward the sun and downward at the Brewster angle at which surfaces maximally polarize reflected light relevant to the reflective surface being used in each experiment (θ_{Brewster}=arctan n≈56° (water), 59° (painted epoxy bird feeder bases). The Brewster angle for these surfaces was 5° greater for ultraviolet light for each object type.

Experiment 1

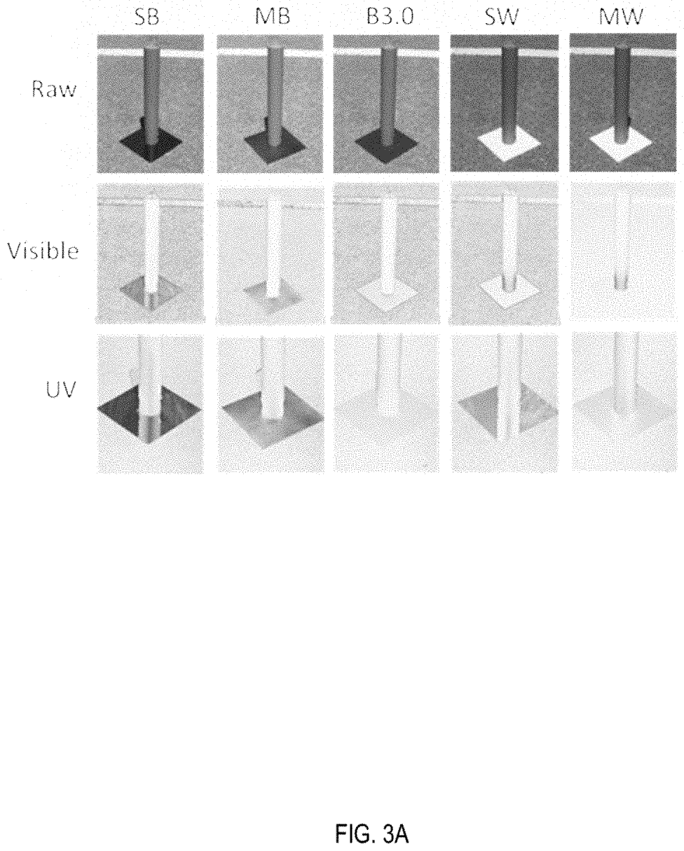

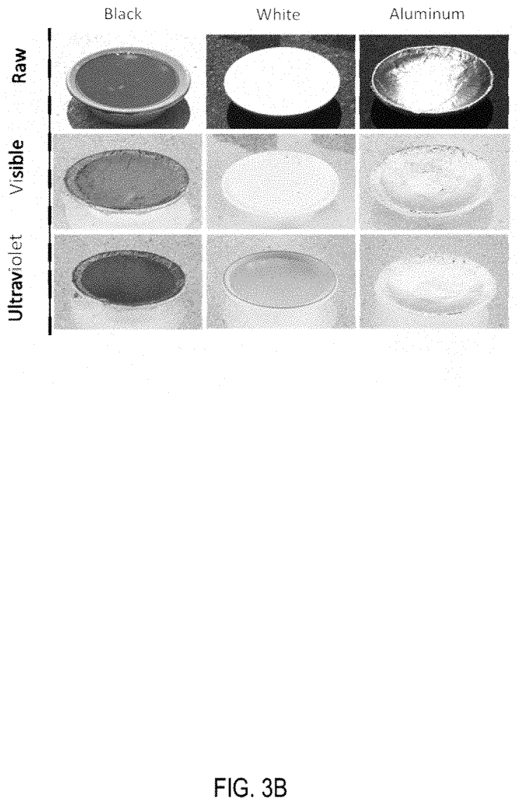

The first experiment was designed to test whether wild songbirds could detect horizontally polarized light and use it to guide their foraging decisions. Hanging bird feeders were built out of PVC tubing and a 18 cm×18 cm piece of 5 mm thick acrylic was attached to the base to act as a visual test surface and feeding platform that catches seed spilling from two openings at the base of the tube, as seen in FIG. 3A.

The acrylic panel base was painted in one of five treatments designed to manipulate the color and horizontal polarization of reflected light: 1) White-shiny, 2) black shiny, 3) white-matte, 4) black-matte ,and 5) black matte 3.0 Shiny treatments were created by painting the bottom of the transparent acrylic feeder with wither black or white gloss spray paint so that the acrylic upper surface acted as a strong polarizer and the paint layer acted as an absorber/reflector of transmitted light. Matte treatments were created by painting the upper side of the acrylic panels with one of three paint types: matte white spray paint, matte black spray paint and Black 3.0™ paint, the darkest most light-absorbing paint available. Feeders were hung from a rotating wrought-iron hanger hammered into the ground and that held four feeders at each of the 90 degree angle intervals. The study was conducted at n=15 sites for each of two separate field seasons, each. In the 2019-2020 season, birds were exposed to feeders with treatments 1-4, while in the 2019-2020 season treatment 4 was replaced with treatment 5 to expose birds to a black treatment with a more strongly reduced polarization signature. The rest of the feeder was painted with a grey matte spray paint to create a color palate intermediate to the base treatments while minimizing its polarization signature.

The feeder assembly was placed at each study site, filled feeders with black oil sunflower seed, and the acrylic bases of each feeder with cardboard to prevent birds from seeing the visual treatments. Once songbirds were observed feeding, an observation period was begun. Behavioral observations were conducted only on rain-free days>1 hour after sunrise and before noon. The observer began by removing the cardboard feeder base covers and moving 30 meters away, waiting two minutes and using binoculars to count how many visits, and by what species, were made to each treatment for one hour. Every 15 minutes the observer approached the feeder, rotating it clockwise 90 degrees to randomize the position of each treatment over the observation period.

Experiment 2

Water bodies possess traits that the artificial polarizing surfaces in experiment 3 do not. These include visual cues associated moving ripples, scent, and tactile properties birds can experience when drinking or bathing. Experiment 2 was designed to test the ability of birds to use polarized light to locate water bodies while including these accessory cues they might use to discriminate between water and non-water.

Heated bird baths (diameter 35 cm) were covered with one of three materials: black plastic sheeting, white plastic sheeting or aluminum foil. Aluminum foil is known to depolarize reflected light of all wavelengths, while the white substrate should cause the water body to polarize only in the ultraviolet range, as seen in FIG. 3B. Baths were plugged into nearby structures and were kept activated for the length of the experiment to prevent water from freezing. Following the design of experiment 2, one bath of each of the three treatments were placed in a row, 0.5 meters apart and 1 m from the tree line with a motion-activated camera on each end of the row. Two bird feeders were placed on the tree line and in front of the experiment to attract birds to the general area. After 24 hours, the feeders were filled and rotated relative to the position of the bird baths. The exposure period for the experiment was three days. An image of one or more birds standing on the bath associated with a visual treatment were considered evidence of a visit to that treatment. This study was conducted in both field seasons until data was collected at n=15 sites over the full length of the study.

Statistical Analysis

Because the relative spatial position of treatments within each experiment was randomized during observation periods, observations were pooled across the whole observation period (experiment 1: 1 hour; experiment 2: four days experiment 3: three days). In order to make visitations data comparable amongst sites with different total numbers of bird detections, capture data was quantitatively adjusted for each treatment and for all three experiments, by converting it to a percentage of total visits to all treatments at that site. Generalized linear models were used to predict the percentage of visits as a function of visual treatment and fitted models to negative binomial, Poisson or Tweedie distributions and ran pairwise post-hoc tests of significance (SPSS 2019). To understanding avian responses to our alternation of the reflection polarization of the black-matte surface in the second year of the feeder study, year and year x treatment interaction term were included in models.

### Results

20 species of woodpecker (Piciformes), dove (Columbifores) and songbird (Passeriformes) songbirds common during the fall and winter in southern New York were detected, as set forth in Table 1 below. The fit of visitation data to models were good and feeder data was fit to Tweedie distributions (1.3<ĉ<2.4) and bird bath data to a Poisson distribution (ĉ=0.98).

TABLE 1

| Common Name | Latin name | Bath | Feeder |
|---|---|---|---|
| American Goldfinch | Spinis tristis | X | |
| Black-capped Chickadee | Peocile atricpillus | X | X |
| Blue Jay | Cyanocitta cristata | X | X |
| Carolina Wren | Thyothorus | | X |
| | ludovicianus | | |
| Common Grackle | Quaiscalus quiscula | X | X |
| Dark-eyed Junco | Junco hyemalis | X | |
| Downy Woodpecker | Picoides pubescens | | X |
| Eastern Bluebird | Sialia sialis | X | |
| European Starling | Sturnus vulgarus | | |
| Field Sparrow | Spizella pusilla | | |
| House Finch | Haemorhous mexicanus | X | X |
| House Sparrow | Passer domesticus | X | x |
| Mourning Dove | Zenaida macoura | X | |
| Northern Cardinal | Cardinalis cardinalis | X | X |
| Purple Finch | Haemorhous purpurus | | X |
| Red-bellied Woodpecker | Melanerpes carolinus | | X |
| Red-winged Blackbird | Agelaius phoeniceus | X | |
| Tufted Titmouse | Baeolophus bicolor | X | X |
| White-breasted Nuthatch | Sitta carolinensis | X | X |
| White-throated Sparrow | Zonotrichia albicollis | X | X |

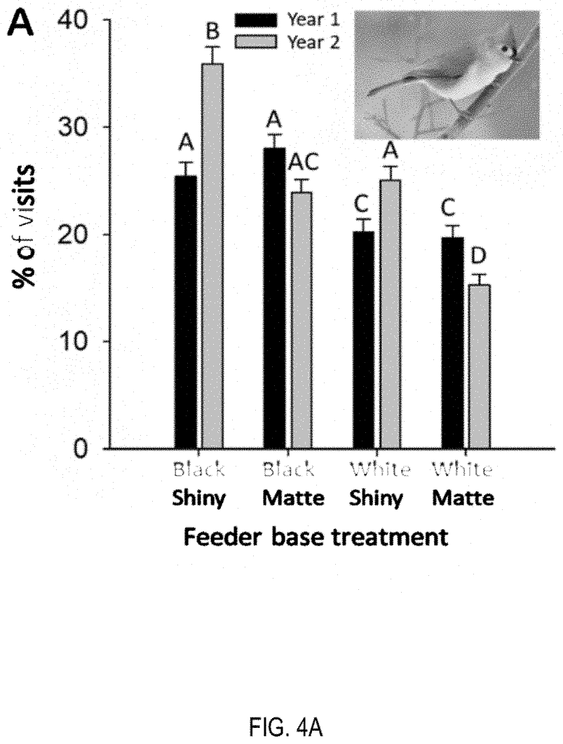

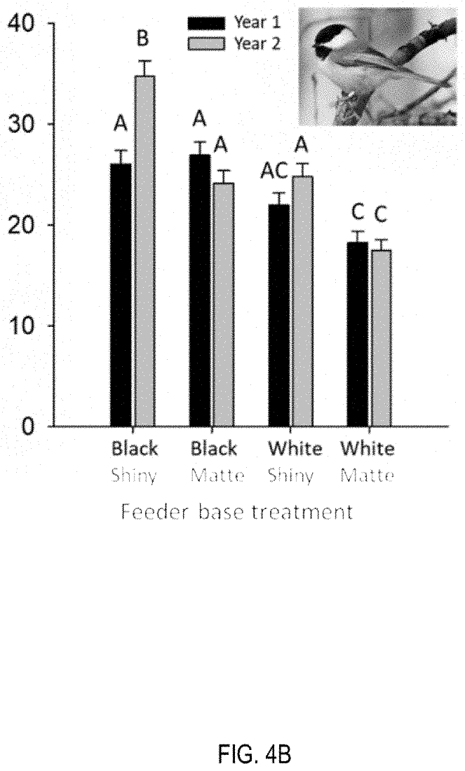

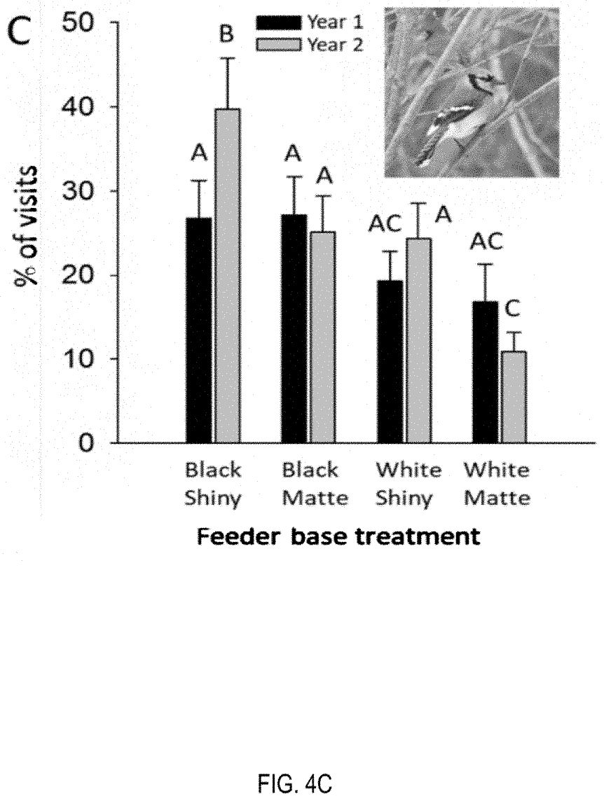

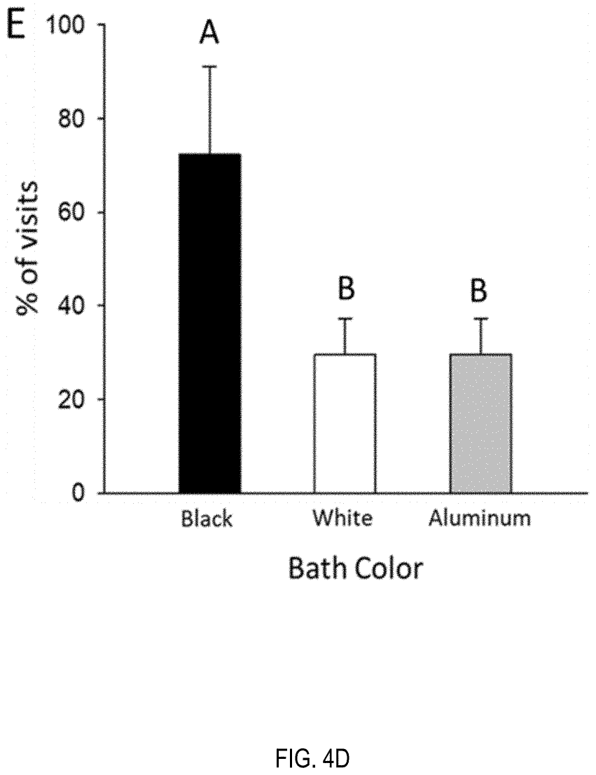

Birds preferentially visited feeders with black shiny (d=87%) and matte (d=71%) test surfaces over those with white-colored bases during the first year of the study, but preferences shifted to strongly favor feeders with black-shiny test surfaces during the second year of the study when we introduced a new reduced-polarization black-matte (d=42%) test surface (Tufted Titmouse: X²ₜᵣₑₐₜₘₑₙₜ=107.4, P<0.001; X²_{year}=0.9, P=0.34; X²_{interaction}=44.5, P<0.001, FIG. 2A; Black-capped Chickadee: X²ₜᵣₑₐₜₘₑₙₜ=94.0, P<0.001; X²_{year}=2.78, P=0.09; X²_{interaction}=18.9 P<0.001, FIG. 2B; All other species combined: X²ₜᵣₑₐₜₘₑₙₜ=14.4, P=0.002; X²_{year}=0.56, P=0.45; X²_{interaction}=15.0 P=0.002, FIG. 2C). Increased preference for black-shiny surfaces in the second year of the study corresponded with a reduction in the attraction for white-matte surfaces that polarized the least percentage of polarized light (d=17%). Birds visiting black-based bird baths twice as often as those coated with white plastic or aluminum foil (All species: X²ₜᵣₑₐₜₘₑₙₜ=7.87, P<0.02, FIG. 4D).

### Discussion

The experiments provide clear, experimental evidence that birds are able to detect terrestrial sources of horizontally polarized light, that they can use that information to help locate water bodies and inform their foraging strategies. The results also suggest that these abilities seem to be somewhat taxonomically widespread.

The feeder study manipulated the color-polarization signature of the feeders, not to simulate the appearance of water bodies to birds, but to see if manipulating their horizontal polarization would make them more visually conspicuous to birds in ways that would affect their selection of a food source.

Year 1: We only know they like black and polarization signatures are similar (black-shiny d=87%, black matte d=71%).

Year 1: Birds didn't distinguish between white matte and white-shiny surfaces that had different polarization signatures (white-shiny d=37%, white matte d=17%).

When Black 3.0 © paint was used to reduce the polarization ability of the white-matte panel to a value similar to the white-shiny panel (d=42%) chickadees and titmice, preference for the highly polarizing black-shiny panel increased relative, attraction to black-matte became similar to that of white-shiny, and a reduced preference for the lowest polarizing white-matte feeder emerged.

This shift in preferences for test surfaces corresponding to our experimental manipulation of polarization shows that two species of songbirds are not only able to see terrestrial sources of horizontally polarized light and that they are attracted to it within the context of feeding, but that there is a threshold for attraction somewhere between degrees of polarization of 77 and 37%, at least in the visible range of light (400-700 nanometers).

The nearly identical responses not only of tufted titmice and black-capped chickadees, the two most abundant visitors to the study, but also the same responses seen from lumping all the other birds observed in the study into one group suggest that these behaviors and the visual thresholds that guide them are far more taxonomically broad and likely extend to all songbird species (order: Passeriformes). The bird bath experiment provided polarization cues typical of water bodies with substrates of various colors along with an unpolarizing (aluminum) control, while providing the other (e.g. tactile) cues that natural water bodies have. This experiment also offers some clues about the relative importance of the spectrum of polarized light birds use in locating water bodies. Because birds strongly preferred black-lined baths which polarized light in visual and ultraviolet range and showed equally low preference for the non-polarizing aluminum bath and the ultraviolet polarizing white-lined bath, it suggest that avian attraction to polarized light is entirely or more heavily based on the presence of polarized light in the visual range (400-700 nm).

Evidence of birds being attracted to mad-made artificial sources of polarized light have suggested the ability of birds to use polarized light to locate water. Water-associated (e.g. ducks) and more terrestrial birds are attracted to open-air ponds of crude oil waste (location citation location citation) where they become engulfed and die, and historical evidence of bird skeletons in tar pits (citations) suggest this association has been a long-lasting one. Obligate water birds such a pelicans, grebes and loons are occasionally found dead, injured or stranded upon and unable to take off from roads and asphalt parking lots and roads.

Photovoltaic solar panels have been noted as strong sources of polarized light pollution, and increasing evidence of large-scale collisions with solar panels resulting in mortality at utility-scale energy facilities avian mortality at utility-scale photovoltaic solar energy facilities has suggested that birds are mistaking solar fields for desert lakes. This contention is further strengthened by recent evidence that birds attracted to solar energy facilities are disproportionately water-associated species, and that birds migrating past solar facilities preferentially descend toward them.

What is claimed is:

1. A bird activity station, comprising a surface configured to horizontally polarize any light reflected by the surface.

2. The bird activity station of claim 1, wherein the bird activity station comprises a bird feeder.

3. The bird activity station of claim 2, the bird feeder comprises a housing for containing bird food and a platform mounted to the housing.

4. The bird activity station of claim 3, wherein the platform forms the substrate that horizontally polarizes the light reflected by the surface.

5. The bird activity station of claim 4, wherein the platform is formed from a transparent polymer and a layer of dark paint applied to an opposing side of the substrate from the housing.

7. The bird activity station of claim 1, wherein the bird activity station comprises a bird bath.

8. The bird activity station of claim 7, wherein the bird bath comprises a bowl having a layer of dark paint applied thereto so that any water placed in the bowl will cooperate with the layer of dark paint to horizontally polarize any light reflected by the surface.
